(19) United States
(12) Patent Application Publication
(10) Pub. No.: US 2026/0329218 A1
(43) Pub. Date: Oct. 22, 2026

(54) IMAGE FORMING APPARATUS

(71) Applicant: CANON KABUSHIKI KAISHA, Tokyo (JP)

(72) Inventors: Hiroki Tanaka, Kanagawa (JP); Akihisa Matsukawa, Tokyo (JP); Yuki Iwamoto, Saitama (JP)

(21) Appl. No.: 19/630,577

(22) Filed: Mar. 27, 2026

(30) Foreign Application Priority Data
Apr. 17, 2025 (JP) 2025-068142

(51) Int. Cl. G03G 15/00; G03G 15/01; G03G 15/08; G03G 21/18

(52) U.S. Cl. CPC G03G 15/556; G03G 15/0121; G03G 15/0126; G03G 15/0189; G03G 15/0856; G03G 15/0865; G03G 15/50; G03G 21/1814

(57) ABSTRACT

Used is an image forming apparatus including: an image carrier; a developing device including a developer carrier and a developing container, the developer carrier supplying a developer to an electrostatic latent image on a surface of the image carrier, the developing container supporting the developer carrier and storing the developer; a replenishing container replenishing the developing container with the developer; and a control unit controlling a replenishing operation, wherein the control unit controls the replenishing operation such that an amount of the developer in the developing container has a predetermined reference value, and makes, when information regarding a total amount of the developer consumed since start of use of the developing device exceeds a first threshold, a target value of the developer stored in the developing container larger than the predetermined reference value.

### BACKGROUND

### Field of the Technology

The present invention relates to an image forming apparatus.

### Description of the Related Art

Conventionally, an image forming apparatus of a type that replenishes toner from a toner replenishing container (toner cartridge) in a case where the amount of toner in a developing container decreases has been manufactured. In particular, many image forming apparatuses of a type in which a toner replenishing container is replaceable with a new toner replenishing container have been manufactured. Such a toner-cartridge replaceable image forming apparatus is advantageous that the amount of waste of a used cartridge is small and the cost of a replacement cartridge can be reduced as compared with a cartridge replaceable image forming apparatus including a cartridge with a toner container and a developing device integrated.

Such a toner-cartridge replaceable image forming apparatus typically has a configuration in which the remaining amount of toner in a developing device is calculated and toner is replenished from a toner replenishing container to the developing device at a predetermined timing. In order to calculate the remaining amount of toner in the developing device, a toner remaining amount detector and a toner usage prediction unit in accordance with printed image information are used.

Incidentally, the toner used with the image forming apparatus typically has a certain degree of particle size distribution. Therefore, toner easily developed and toner hardly developed are mixed in the developing device.

In order to cope with such a situation, Japanese Patent Laid-Open No. 2002-287439 and Japanese Patent No. 5118881 propose a configuration in which toner in a developing device is discharged to, for example, a waste toner container through a photosensitive drum in a state where the amount of toner remaining in the developing device is small at the time of replacing the toner cartridge. According to this configuration, in the state where the remaining amount of toner in the developing device is small, toner hardly to be developed such as large particle size toner has a high ratio, and thus the toner hardly to be developed can be efficiently discharged to the waste toner container or the like.

However, in such a configuration as in the related art, the discharging operation takes a long time, and thus, a long down time has occurred until a necessary amount of toner is discharged. Further, in the configuration in which toner discharge and replenishment are executed with a new toner cartridge, because the execution timing of the toner discharge is determined depending on the life of the toner cartridge to be used, flexibility of the timing has been lacked. Furthermore, in the configuration in which discharge is executed in a state where the remaining amount of toner is small, the physical properties of the toner have been rapidly changed.

### SUMMARY

The present disclosure has been made in view of the above drawbacks, and an object of the present disclosure is to provide an image forming apparatus that enables suppression of an adverse effect on an image due to a change in the physical properties of toner in a configuration that enables toner replenishment to a process cartridge.

The present disclosure provides an image forming apparatus comprising:
an image carrier having a surface on which an electrostatic latent image is to be formed;
a developing device including a developer carrier and a developing container, the developer carrier configured to supply a developer to the electrostatic latent image, the developing container configured to support the developer carrier and to store the developer;
a replenishing container configured to replenish the developing container with the developer; and
a control unit configured to control a replenishing operation of the developer from the replenishing container to the developing container,
wherein
the control unit
   controls the replenishing operation such that an amount of the developer stored in the developing container becomes a predetermined reference value, and
   increases a target value of the amount of the developer stored in the developing container from the predetermined reference value, in a case where consumption amount-related information regarding a total amount of the developer consumed since start of use of the developing device exceeds a first threshold.

The present disclosure also provides an image forming apparatus comprising:
a first image carrier and a second image carrier each having a surface on which an electrostatic latent image is to be formed;
a first developing device including a first developer carrier and a first developing container, the first developer carrier configured to supply a first developer to the electrostatic latent image on the first image carrier, the first developing container configured to support the first developer carrier and to store the first developer;
a second developing device including a second developer carrier and a second developing container, the second developer carrier configured to supply a second developer to the electrostatic latent image on the second image carrier, the second developing container configured to support the second developer carrier and to store the second developer;
a first replenishing container configured to replenish the first developing container with the first developer;
a second replenishing container configured to replenish the second developing container with the second developer; and
a control unit configured to control a replenishing operation of the first developer from the first replenishing container to the first developing container and a replenishing operation of the second developer from the second replenishing container to the second developing container,
wherein
the control unit
   controls the replenishing operation such that an amount of the first developer stored in the first developing container becomes a predetermined reference value and controls the replenishing operation such that an amount of the second developer stored in the second developing container becomes a predetermined reference value, and
   increases, in a case where a consumption amount difference obtained by subtracting second consumption amount-related information regarding a total amount of the second developer consumed since start of use of the second developing device from first consumption amount-related information regarding a total amount of the first developer consumed since start of use of the first developing device exceeds a third threshold, a target value of the amount of the first developer stored in the first developing container from the predetermined reference value.

The present disclosure also provides an image forming apparatus comprising:
a first image carrier and a second image carrier each having a surface on which an electrostatic latent image is to be formed;
a first developing device including a first developer carrier and a first developing container, the first developer carrier configured to supply a first developer to the electrostatic latent image on the first image carrier, the first developing container configured to support the first developer carrier and to store the first developer;
a second developing device including a second developer carrier and a second developing container, the second developer carrier configured to supply a second developer to the electrostatic latent image on the second image carrier, the second developing container configured to support the second developer carrier and to store the second developer;
a first replenishing container configured to replenish the first developing container with the first developer;
a second replenishing container configured to replenish the second developing container with the second developer; and
a control unit configured to control a replenishing operation of the first developer from the first replenishing container to the first developing container and a replenishing operation of the second developer from the second replenishing container to the second developing container,
wherein
the control unit
   controls the replenishing operation such that an amount of the first developer stored in the first developing container becomes a predetermined reference value and controls the replenishing operation such that an amount of the second developer stored in the second developing container becomes a predetermined reference value, and
   decreases, in a case where a consumption amount difference obtained by subtracting second consumption amount-related information regarding a total amount of the second developer consumed since start of use of the second developing device from first consumption amount-related information regarding a total amount of the first developer consumed since start of use of the first developing device exceeds a third threshold, a target value of the amount of the second developer stored in the second developing container from the predetermined reference value.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic sectional view of an image forming apparatus of Example 1.

FIG. 2 is a schematic sectional view of a process cartridge of Example 1.

FIG. 3A is a schematic view of a toner remaining amount detection unit of Example 1.

FIG. 3B is a top view of a light reflective member of the toner remaining amount detection unit of Example 1.

FIG. 3C is a graph indicating a relationship between the light quantity of a light quantity detection sensor and the remaining amount of toner in a developing container in Example 1.

FIG. 3D is a schematic view of an exemplary toner remaining amount detection unit of Example 1.

FIG. 4 is a schematic diagram of the control aspect of the image forming apparatus of Example 1.

FIG. 5 is a graph indicating a relationship between the total usage of toner and the average particle size in Example 1.

FIG. 6 is a graph indicating a relationship between the total usage of toner per average coverage rate and the average particle size in Example 1.

FIG. 7 is a schematic graph indicating a target value of the light quantity when the remaining amount of toner is changed in Example 1.

FIG. 8 is a graph indicating the average particle size in the case of a plurality of total toner usage thresholds in Example 1.

FIG. 9 is a schematic graph indicating a target value of the light quantity in the case of a plurality of total toner usage thresholds in Example 1.

FIG. 10A is a graph indicating a variation in average particle size in a case where the average coverage rate is different for each color in Example 2.

FIG. 10B is a graph indicating control for increasing the remaining amount in the case where the average coverage rate is different for each color in Example 2.

FIG. 10C is a graph indicating control for decreasing the remaining amount in the case where the average coverage rate is different for each color in Example 2.

### DESCRIPTION OF THE EMBODIMENTS

Hereinafter, examples of the present disclosure will be described in detail with reference to the drawings. However, the dimensions, materials, shapes, relative arrangements, and the like of the components described in the following examples should be appropriately changed according to the configuration of the apparatus to which the present disclosure is applied and various conditions. Therefore, the scope of the present disclosure is not limited unless otherwise specified. Although a plurality of features are described in the examples, all of the plurality of features are not necessarily essential to the disclosure, and the plurality of features may be freely combined.

### Example 1

Example 1 of the present disclosure will be described. An image forming apparatus 1 of the present example includes four process cartridges 3 as developing devices and four toner replenishment units 20 as replenishing containers. The number of the process cartridges 3 and the toner replenishment units 20 attached to the image forming apparatus is not limited thereto, and can be appropriately set as necessary. In the present example, a laser beam printer is illustrated as an aspect of the image forming apparatus.

### Schematic Configuration of Image Forming Apparatus

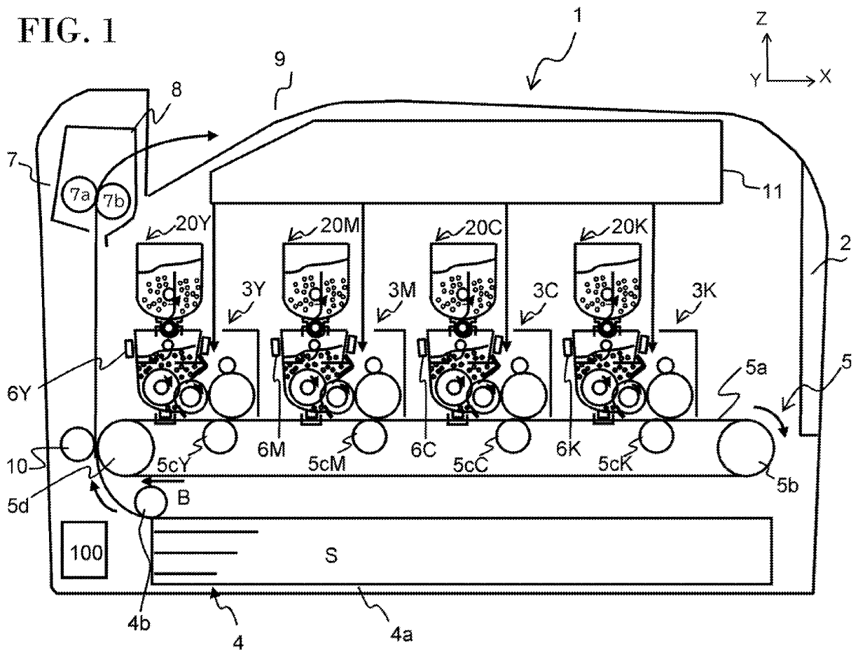

FIG. 1 is a schematic sectional view of the image forming apparatus 1.

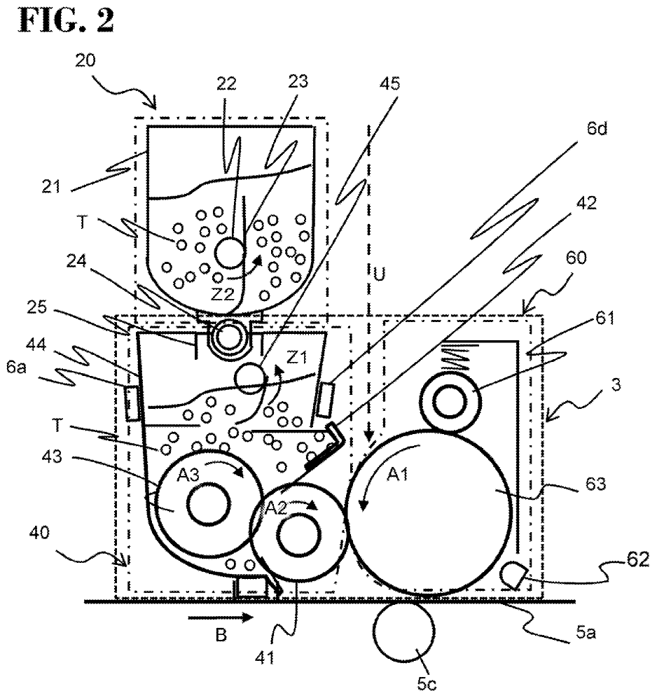

FIG. 2 is a sectional view of a process cartridge 3 and a toner replenishment unit 20. In the present disclosure, the upward direction in the drawing is the upward direction in the gravity direction (Z direction in the drawing).

The image forming apparatus 1 is a full-color laser printer in four colors using an electrophotographic process, and forms a color image on a recording medium S. The image forming apparatus 1 is of a process cartridge type, and the process cartridges 3 are each detachably attached to the main body of the image forming apparatus through a front door 2. In the main body of the image forming apparatus 1, the first to fourth process cartridges 3 (3Y, 3M, 3C, and 3K) are disposed in a substantially horizontal direction.

The first to fourth process cartridges 3 (3Y, 3M, 3C, and 3K) have the same electrophotographic process mechanism, and the colors of the developer (hereinafter referred to as toner) are different from each other. Hereinafter, in a case where it is not particularly necessary to distinguish, the suffix (Y: yellow, M: magenta, C: cyan, and K: black) indicating the color is omitted. A rotational driving force is transmitted from a drive output unit 121 included in the main body of the image forming apparatus to the process cartridges 3.

A bias voltage is supplied from the main body of the image forming apparatus to each element of the process cartridges 3. For example, a charging voltage is applied from a charging power supply 111 to a charging roller 61. A developing voltage is applied from a developing power supply 112 to a developing roller 41. A regulating voltage is applied to a developing blade 42 from a regulation power supply 113. A transfer voltage is applied from a transfer power supply 114 to a primary transfer roller 5c and a secondary transfer roller 10.

As illustrated in FIG. 2, each of the process cartridges 3 includes a drum unit 60 including a photosensitive drum 63 as an image carrier and a charging roller 61 as a charger as a process unit acting on the photosensitive drum 63. Here, the drum unit 60 may include not only the charger but also a cleaning unit as a process unit. Further, the process cartridge 3 includes a developing unit 40 provided with a developing roller 41 as a developer carrier that develops an electrostatic latent image on the photosensitive drum 63. The first to fourth toner replenishment units 20 (20Y, 20M, 20C, and 20K) are connected to the first to fourth process cartridges 3 (3Y, 3M, 3C, and 3K). The drum unit 60, the developing unit 40, and the toner replenishment unit 20 are connected to each other. A more specific configuration of the process cartridge 3 will be described later.

The first process cartridge 3Y and the first toner replenishment unit 20Y store the yellow (Y) toner T in the developing container 44, and form a yellow toner image on the surface of the photosensitive drum 63. The second process cartridge 3M and the second toner replenishment unit 20M store the magenta (M) toner T in the developing container 44, and form a magenta toner image on the surface of the photosensitive drum 63. The third process cartridge 3C and the third toner replenishment unit 20C store the cyan (C) toner T in the developing container 44, and form a cyan toner image on the surface of the photosensitive drum 63. The fourth process cartridge 3K and the fourth toner replenishment unit 20K store the black (K) toner T in the developing container 44, and form a black toner image on the surface of the photosensitive drum 63.

Each toner remaining amount detection unit 6 having a toner remaining amount detection substrate 6a is disposed near the corresponding developing container 44. The toner remaining amount detection unit 6 estimates the surface level of toner to read the remaining amount of toner in the developing container 44. The detailed operation will be described later in the section of the operation of the process cartridge.

A laser scanner unit 11 as an exposure unit is provided above the process cartridges 3. The laser scanner unit 11 outputs a laser beam U corresponding to image information to scan and expose the surface of each photosensitive drum 63.

An intermediate transfer unit 5 as a transfer member is provided below the process cartridges 3. The intermediate transfer unit 5 includes a driving roller 5d, a tension roller 5b, and a flexible transfer belt 5a stretched around the driving roller 5d and the tension roller 5b. The lower surface of the photosensitive drum 63 of the process cartridge 3 is in contact with the upper face of the transfer belt 5a. The contact portion is a primary transfer portion. A primary transfer roller 5c is provided inside the transfer belt 5a and faces the photosensitive drum 63. A secondary transfer roller 10 is brought into contact with the driving roller 5d through the transfer belt 5a. A contact portion between the transfer belt 5a and the secondary transfer roller 10 is a secondary transfer portion.

A feeding unit 4 is provided below the intermediate transfer unit 5. The feeding unit 4 includes a sheet feeding tray 4a with recording media S stacked and stored therein, and a sheet feeding roller 4b. A fixing device 7 and a sheet ejection device 8 are provided at left, above in the main body of the image forming apparatus in FIG. 1. The upper face of the main body of the image forming apparatus serves as a sheet ejection tray 9. The toner image on the recording medium S is fixed by the fixing device 7 as a fixing unit and ejected to the sheet ejection tray 9. The fixing device 7 including a fixing roller 7a and a heating roller 7b causes a recording medium S to pass through a fixing nip portion between the fixing roller 7a and the heating roller 7b, melts the toner T by heat generated from a heater inside the heating roller 7b, and fixes the toner T to the recording medium S.

The drive output unit 121 is a driver including various drive elements including a drive source such as a motor and a transmission element such as a gear and a belt. The drive output unit 121 generates and transmits, for example, a rotational driving force to a rotary element included in the image forming apparatus 1 and a driving force to an opening/closing element such as a shutter. The drive output unit 121 may be configured to distribute the driving force of a single drive source, or may include a plurality of drive sources.

### Image Forming Operation

The operation for full-color image formation is as follows. The photosensitive drum 63 of the process cartridge 3 is rotationally driven at a predetermined speed (the direction of Arrow A1 in FIG. 2). In the case of the image forming apparatus 1 of the present example, the printing rate at the time of continuously passing A4-size sheets is 36 sheets per minute, and the peripheral face of the photosensitive drum 63 rotates at 180 mm/sec.

The transfer belt 5a is rotationally driven at a speed corresponding to the speed of the photosensitive drum 63 in the forward direction (the direction of Arrow B in FIG. 2) with the rotation of the photosensitive drum 63. The charging roller 61 comes into contact with the photosensitive drum 63 with a predetermined pressing force, and a desired charging voltage is applied to uniformly charge the surface of the photosensitive drum 63 to a predetermined potential.

The laser scanner unit 11 is also driven. In synchronization with the driving of the laser scanner unit 11, in the process cartridge 3, the charging roller 61 uniformly charges the surface of the photosensitive drum 63 to a predetermined polarity and potential. The laser scanner unit 11 outputs a laser beam U on the basis of an image signal to scan and expose the surface of the photosensitive drum 63. As a result, an electrostatic latent image based on the image signal is formed on the surface of the photosensitive drum 63. The formed electrostatic latent image is developed by the developing roller 41 that is rotationally driven at a predetermined speed.

### Operation of Process Cartridge

Subsequently, the process cartridge 3 will be described in detail. As illustrated in FIG. 2, the process cartridge 3 includes the developing unit 40. The developing unit 40 includes the developing roller 41 as a developer carrier that carries a developer, the developing container 44 as a container for the developing unit 40, and a supply roller 43 that can supply the developer to the developing roller 41. The developing roller 41 is rotatably supported in the direction of Arrow A2 by the developing container 44. The supply roller 43 is also rotatably supported in the direction of Arrow A3 by the developing container 44. The developing roller 41 is disposed in an opening of the developing container 44 and faces the photosensitive drum 63. The supply roller 43 is in contact with the developing roller 41. The toner T as a developer stored in the developing container 44 is applied to the surface of the developing roller 41 by the supply roller 43.

The toner replenishment unit 20 is a so-called toner cartridge and has the toner T inside the toner container. The toner replenishment unit 20 is disposed above the developing container 44, and is mutually connected to the developing container 44 through a developing opening 25. The toner replenishment unit 20 is replaceable by a user. A toner replenishment shutter 24 is disposed at a connecting portion between the toner replenishment unit 20 and the developing container 44. The toner replenishment shutter 24 is opened or closed at any timing by the drive control from a control unit 100, and causes the toner replenishment unit 20 and the developing container 44 to communicate with each other.

A toner replenishment stirring shaft 22 and a toner replenishment stirring sheet 23 are disposed in the toner replenishment unit 20, and rotate counterclockwise indicated by Arrow Z2 in FIG. 2. The toner T in the toner replenishment unit 20 is circulated by the toner replenishment stirring sheet 23, and the toner T is conveyed from the toner replenishment unit 20 to the developing container 44. In the present example, the toner replenishment stirring shaft 22 is configured to always rotate during the drive of the process cartridge 3, and the toner T replenishing operation is controlled by opening or closing the toner replenishment shutter 24. The control unit 100 receives a signal from the toner remaining amount detection substrate 6a, drives the toner replenishment shutter 24 such that the remaining amount of toner in the developing container 44 is constant, and executes the toner T replenishing operation.

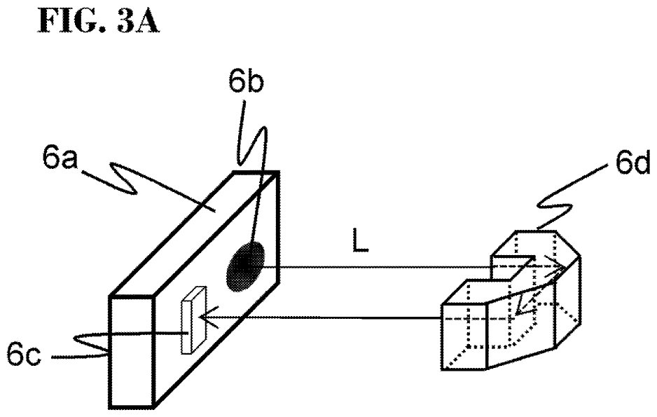

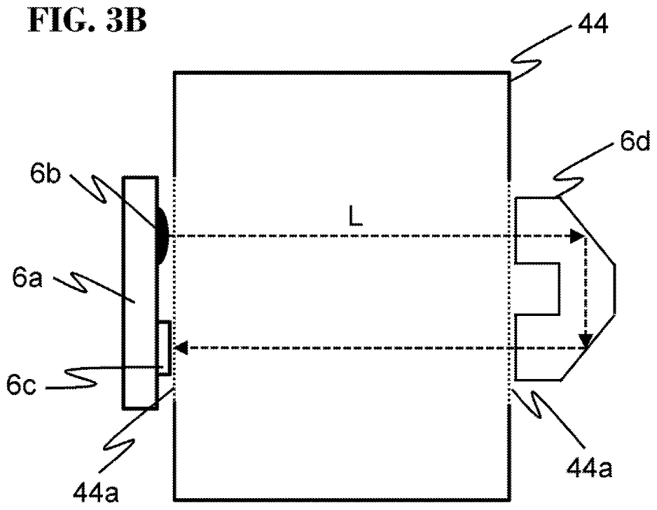

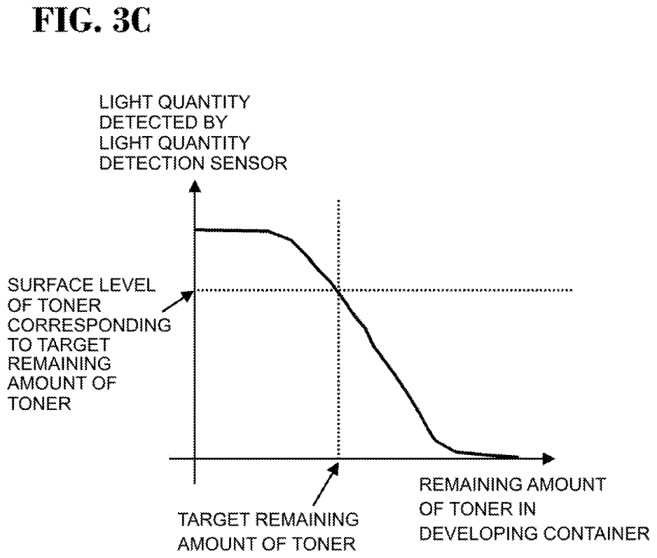

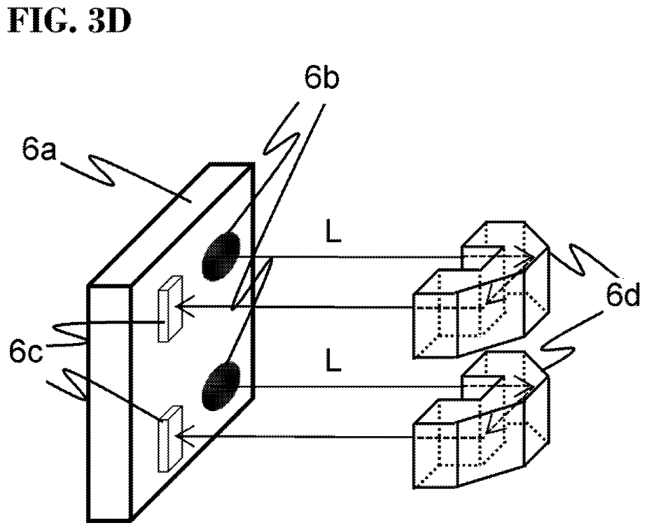

FIG. 3A is a schematic view of the toner remaining amount detection unit 6. FIG. 3B is a schematic view of a positional relationship among the toner remaining amount detection substrate 6a, the light reflective member 6d, the developing container 44, and light L as viewed from above in the direction of gravity of the developing unit 40. The lower part of FIG. 3B is the front side of the schematic view of the process cartridge 3 in FIG. 2.

The toner remaining amount detection substrate 6a is disposed near the developing container 44 inside the image forming apparatus. On the toner remaining amount detection substrate 6a, an LED light emitting element 6b whose light emission is controlled at any timing by the control unit 100 and a light quantity detection sensor 6c are disposed. The light reflective member 6d is secured to a wall face of the developing container 44 facing the toner remaining amount detection substrate 6a.

The LED light emitting element 6b of the toner remaining amount detection substrate 6a emits light L having directivity in the direction of the light reflective member 6d. The wall face of the developing container 44 located on the optical path of light L emitted from the LED light emitting element 6b has a transparent window 44a made of, for example, acrylic resin and the transparent window 44a suppresses the reflection or absorption of light L.

The emitted light L crosses the inside of the developing container 44, and is reflected on the light reflective member 6d toward the light quantity detection sensor 6c of the toner remaining amount detection substrate 6a. The light quantity of the light L reflected and returned is read by the light quantity detection sensor 6c. At this time, the detected light quantity greatly varies depending on the surface level of toner in the developing container 44. As the ratio at which the toner blocks the optical path is high, the detected light quantity is small, and as the ratio at which the toner blocks the optical path is low, the detected light quantity is large. By reading the intensity of the light quantity, the remaining amount of toner in the developing container 44 can be estimated. The information regarding the toner detected by the light quantity detection sensor 6c is correlated with the surface level of toner.

FIG. 3C is a graph indicating a relationship between the remaining amount of toner in the developing container 44 and the surface level of toner detected by the toner remaining amount detection substrate 6a. In a case where a predetermined surface level of toner is detected on the basis of the detection result, the control unit 100 determines that the amount of toner in the developing container 44 is the target remaining amount of toner.

In the present example, the control unit 100 reads a signal from the toner remaining amount detection substrate 6a and drives the toner replenishment shutter 24 such that the remaining amount of toner T in the developing container 44 is maintained at an average of about 40 g. Specifically, the control unit 100 starts a replenishing operation in a case where the amount of toner in the developing container 44 reaches 37 g, in accordance with the signal from the toner remaining amount detection substrate 6a, and executes the replenishing operation until the amount of toner in the developing container 44 is detected to be 43 g. As a result, the amount of toner in the developing container 44 transitions between 37 g and 43 g, and the average remaining amount is maintained at 40 g.

In the present example, the toner remaining amount detector that is a detector using light is exemplified as a unit that estimates the remaining amount of toner in the developing container 44, but the unit for estimating the remaining amount of toner is not limited thereto. For example, the amount of used toner may be estimated from printed image information, and the remaining amount of toner may be calculated.

In a case where the amount of toner in the toner replenishment unit 20 decreases and replacement of the toner replenishment unit 20 is approaching, the control unit 100 executes control to notify the user of the toner LOW. Further, in a case where the amount of toner in the toner replenishment unit 20 decreases and the toner replenishment to the developing container 44 is impossible, the control unit 100 executes control to notify the user of the toner OUT and executes control to request replacement of the toner replenishment unit 20.

In the present example, the control unit 100 estimates the remaining amount of toner in the toner replenishment unit 20 from the relationship between the number of toner replenishing operations by opening and closing of the toner replenishment shutter 24 and the increased amount of toner in the developing container 44, and notifies the user of the toner LOW or the toner OUT. That is, in a case where the increased amount of toner in the developing container 44 relative to the number of toner replenishing operations is smaller than a predetermined value, it is determined as the toner LOW, and in a case where the amount of toner in the developing container 44 no longer increases due to the number of toner replenishing operations, it is determined as the toner OUT.

Further, in order to widely detect the remaining amount of toner in the developing container 44, for example, as illustrated in FIG. 3D, two toner remaining amount detection substrates 6a and two light reflective members 6d may be disposed longitudinally in the gravity direction such that the light quantity of light L varies for a wider variation in the surface level of toner.

The method of detecting the remaining amount of toner in the toner replenishment unit 20 is not limited thereto, and thus the remaining amount of toner may be estimated from image information printed by the user. Further, the toner remaining amount detector may be mounted on the toner replenishment unit 20.

The developing unit 40 of the present example uses a contact development method as a developing method. That is, the toner layer carried on the developing roller 41 is brought into contact with the photosensitive drum 63 in a developing portion (developing region) where the photosensitive drum 63 and the developing roller 41 face each other. A developing voltage is applied to the developing roller 41. Under a condition where the developing voltage is applied, the toner carried on the developing roller 41 is transferred from the developing roller 41 to the surface of the photosensitive drum 63 in accordance with the electrostatic latent image on the surface of the photosensitive drum 63, such that a toner image is developed.

In the present example, the developing voltage is-300 V. In the present example, a reversal development method is adopted. That is, the surface of the photosensitive drum 63 is charged by the charging roller 61, and then the surface of the photosensitive drum 63 is exposed in the exposure step. Toner from the developing roller 41 adheres to an exposure region that is the surface of the photosensitive drum 63 with the amount of charge attenuated by the exposure, whereby a toner image is formed. After the toner image is transferred to the transfer belt 5a, the surface of the photosensitive drum 63 is neutralized by a pre-exposure member 62 to make the potential uniform. Thereafter, the photosensitive drum 63 is charged again by the charging roller 61.

In addition, in the present example, the toner T having a particle size of 7 μm and a normal charge polarity that is negative is used. As the toner T, for example, a polymerized toner generated by a polymerization method can be employed. The toner T does not contain a magnetic component, and is a so-called non-magnetic single-component developer in which the toner T is mainly carried on the developing roller 41 by an intermolecular force or electrostatic force (image force).

The toner particles contain a plurality of waxes for adjusting the melting characteristics of the toner T during the fixing process and the adhesion to the recording material and to the fixing roller. Fine particles formed of silica particles having a submicron-order particle size are added to the surfaces of the toner particles to adjust the fluidity and chargeability of the toner T. In the present example, toner T to which fine particles are added is defined as a developer.

In the present example, although a non-magnetic single-component developer is used as an example, a single-component developer containing a magnetic component may be used. As the developer, a two-component developer composed of a nonmagnetic toner and a magnetic carrier may be used. In a case where a developer having magnetism is used, for example, a cylindrical developing sleeve with a magnet disposed therein is used as a developer carrier.

A stirring member 45 as a stirring unit is provided inside the developing container 44. The stirring member 45 is driven to rotate in the direction of Arrow Z1, thereby stirring the toner T in the developing container 44 and feeding the toner T toward the developing roller 41 and the supply roller 43. In addition, the stirring member 45 has a role of circulating the toner T not used for development but peeled off from the developing roller 41 in the developing container making the toner T uniform in the developing container.

In addition, the developing blade 42 made of a stainless steel plate that regulates the amount of toner to be carried on the developing roller 41 is disposed in the opening of the developing container 44 with the developing roller 41 disposed therein. A voltage that is 200 V greater in absolute value on the negative polarity side relative to the developing roller 41 is applied to the developing blade 42 from the regulation power supply 113. That is, a voltage 200 V larger on the normal polarity side of the toner T is applied to the developing blade 42.

The developer supplied to the surface of the developing roller 41 passes through a portion facing the developing blade 42 with the rotation of the developing roller 41, such that the developer is evenly thinned. At the same time, the toner undergoes direct charge injection by frictional charging with the developing blade 42 and a potential difference provided between the developing blade 42 and the developing roller 41, and is charged to the negative polarity that is the normal polarity of the toner.

In the embodiment of the present example, a so-called cleaner-less configuration is adopted in which transfer residual toner remaining on the photosensitive drum 63 without being transferred to the recording medium S is recovered to the developing unit 40 and reused. The transfer residual toner is reused in the following steps. The transfer residual toner includes a mixture of toner T charged with a positive polarity, which is opposite to the normal polarity in the present example, and toner T charged with a negative polarity but lacking a sufficient amount of charge. The toner T is uniformly charged to the negative polarity by discharging the bias on the negative polarity side of the charging roller 61 during the charging step of the photosensitive drum 63 by the charging roller 61.

The transfer residual toner charged to the negative polarity reaches the developing region with the rotation of the photosensitive drum 63. Here, the behavior of the transfer residual toner that has reached the developing region will be described separately for the exposed area and the non-exposed area of the photosensitive drum 63. In the non-exposed area of the photosensitive drum 63, namely, a dark potential portion, the surface potential of the photosensitive drum 63 is greater on the negative polarity side than the developing voltage applied to the developing roller 41. Therefore, the transfer residual toner having a sufficient negative charge moves to the developing roller 41 by Coulomb force due to the electric field and is recovered into the developing container 44. Here, the dark potential portion of the photosensitive drum 63 is not limited to the non-exposed area, and weak exposure may be executed when the surface potential of the photosensitive drum 63 is greater on the negative polarity side than the developing voltage applied to the developing roller 41.

The toner recovered in the developing container 44 is stirred with and dispersed in the toner in the developing container 44 by the stirring member 45, and is carried by the developing roller 41 to be used again in the developing process.

On the other hand, in an exposed area of the photosensitive drum 63, because the surface potential of the photosensitive drum 63 is smaller on the negative polarity side than the developing voltage applied to the developing roller 41, the transfer residual toner remains on the surface of the photosensitive drum 63 without being transferred from the photosensitive drum 63 to the developing roller 41 in the developing region. The transfer residual toner remaining on the surface of the photosensitive drum 63 is carried on the photosensitive drum 63 together with other toner transferred from the developing roller 41 to the exposed area, moves to the transfer unit, and is transferred to the recording medium S in the transfer unit.

In the present example, the dark potential portion is −500 V, and the exposure potential portion is −50 V. As described above, because the developing voltage is −300 V, the back contrast that is the potential difference between the dark potential portion of the photosensitive drum 63 having passed through the abutment portion with the charging roller 61 and the developing voltage (the surface potential of the developing roller 41) is Δ200 V. Further, the development contrast that is the potential difference between the exposed area of the photosensitive drum 63 and the developing voltage (surface potential of the developing roller 41) is Δ250 V.

Through the above-described electrophotographic image forming process operation, a yellow toner image corresponding to a yellow component of the full-color image is formed on the photosensitive drum 63 of the first process cartridge 3Y. The toner image is primarily transferred to the transfer belt 5a. Likewise, a magenta toner image corresponding to a magenta component of the full-color image is formed on the photosensitive drum 63 of the second process cartridge 3M. The toner image is primarily transferred to be layered on the yellow toner image that has been already transferred to the transfer belt 5a. Likewise, a cyan toner image corresponding to a cyan component of the full-color image is formed on the photosensitive drum 63 of the third process cartridge 3C. The toner image is primarily transferred to be layered on the yellow and magenta toner images that have been already transferred to the transfer belt 5a. Likewise, a black toner image corresponding to a black component of the full-color image is formed on the photosensitive drum 63 of the fourth process cartridge 3K. The toner image is primarily transferred to be layered on the yellow, magenta, and cyan toner images that have been already transferred to the transfer belt 5a.

In this way, full-color unfixed toner images of four colors including yellow, magenta, cyan, and black are formed on the transfer belt 5a.

On the other hand, the recording media S are separated and fed one by one at a predetermined control timing. The recording medium S is introduced into the secondary transfer portion that is an abutment portion between the secondary transfer roller 10 and the transfer belt 5a at the predetermined control timing.

As a result, while the recording medium S is being conveyed to the secondary transfer portion, the four-color layered toner images on the transfer belt 5a are sequentially and collectively transferred to the surface of the recording medium S.

### Control Aspect

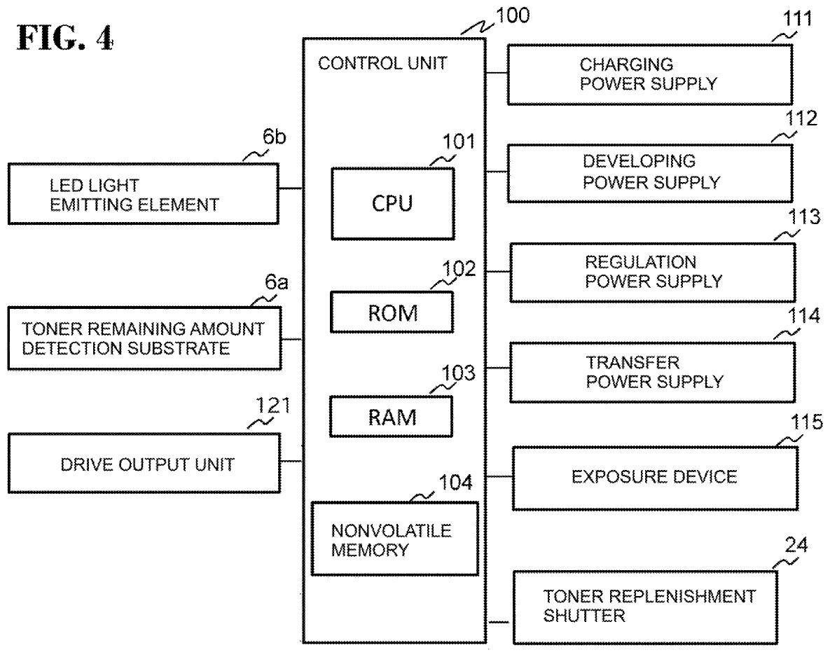

FIG. 4 is a schematic block diagram illustrating the control aspect of a main part of the image forming apparatus 1 according to the present example. The image forming apparatus 1 includes the control unit 100. The control unit 100 includes a CPU 101 as an arithmetic control unit that is a central element for executing arithmetic processing, a storage element such as a ROM 102, a RAM 103, or a nonvolatile memory 104 as a storage unit, an input/output unit (not illustrated) that controls transmission and reception of signals between various elements connected to the control unit 100, and others. The RAM 103 stores a detection result of a sensor, an arithmetic result, and others, and the ROM 102 stores a control program, a data table obtained in advance, and others.

The control unit 100 is a controller that integrally controls the operation of the image forming apparatus 1. The control unit 100 executes a predetermined image forming sequence by controlling transmission and reception of various electrical information signals, drive timing, and others. Each unit of the image forming apparatus 1 is connected to the control unit 100. For example, in the relationship with the present example, the charging power supply 111, the developing power supply 112, the regulation power supply 113, the transfer power supply 114, an exposure device 115, the toner replenishment shutter 24, the drive output unit 121, the LED light emitting element 6b, the toner remaining amount detection substrate 6a, and others are connected to the control unit 100.

### Replacement of Each Unit Cartridge

In a case where the remaining amount of toner inside the toner replenishment unit 20 is small, the control unit 100 notifies the user of replacement with a new product. In addition, the developing unit 40 and the drum unit 60 are integrated into the process cartridge 3, and the process cartridge 3 is detachably attachable to the image forming apparatus 1. In the present example, the toner replenishment unit 20 and the process cartridge 3 can be replaced separately and independently.

The developing roller 41, the developing blade 42, the supply roller 43, the photosensitive drum 63, the charging roller 61, the toner T, and others deteriorate during the use by the user, and it is difficult to provide a sufficient image quality from a certain amount of use. In the image forming apparatus 1 according to the present example, the deterioration of each member and the toner T is predicted on the basis of the rotational speeds of the developing roller 41 and the photosensitive drum 63. That is, when a threshold is exceeded, the control unit 100 controls to notify the user of the end of life of the process cartridge 3 and the replacement with a new product. In the present example, for example, in a case where the user executes continuous printing on every two sheets on average, in a case where 50000 sheets in total are printed, the control unit 100 notifies the user of presumption of the end of life of the process cartridge 3 and the replacement with a new cartridge.

### Increase in Particle Size of Toner

The toner T used for the image forming apparatus is formed of powder with average particle size of about 7 μm having a certain degree of particle size distribution. Therefore, it is impossible to make the physical properties (e.g., particle size, shape, and charge amount) of each particle of the toner T identical. As a result, toner T easily developed and toner T hardly developed are mixed in the developing container 44. For example, in a contact developing system for a single component, typically, the toner T having a small particle size is likely to be developed, and the toner T having a large particle size is not likely to be developed.

The following phenomenon is typically known as the reason why the toner T having the small particle size is more easily developed. In the contact development of the single component as in the present example, the toner Tis charged on the surface, a mirror image force to the developing roller 41 is generated and conveyed to the regulating portion by the developing blade 42. The conveyed toner is regulated to have a constant layer thickness by the developing blade 42. In order to regulate the toner T to have a constant layer thickness, the developing blade 42 abuts on the developing roller 41 with a certain pressure, and the developing roller 41 rotates while maintaining a constant gap with the developing blade 42.

Therefore, in a case where the toner T passes through the gap between the developing roller 41 and the developing blade 42, the toner T having the smaller particle size is more likely to pass through the gap between the developing blade 42 and the developing roller 41 in terms of shape, and the toner T having the larger particle size is less likely to pass through the gap. As a result, the toner T passing through the regulating portion of the developing blade 42 has a large number of particles smaller in size, and the toner T to be developed and consumed also has a high ratio of particles smaller in size.

As the state in which the toner T having the small particle size is preferentially consumed continues and the usage of toner increases, the ratio of the toner T having the large particle size in the developing container 44 is higher than that in the initial use. As a result, because of the increase in the average particle size of the toner T in the developing container 44, the fixability or the like may change and image quality may deteriorate. Note that the amount of toner in the developing container 44 of the present example is controlled to fall within a range of 37 g to 43 g, and the average amount of toner is about 40 g.

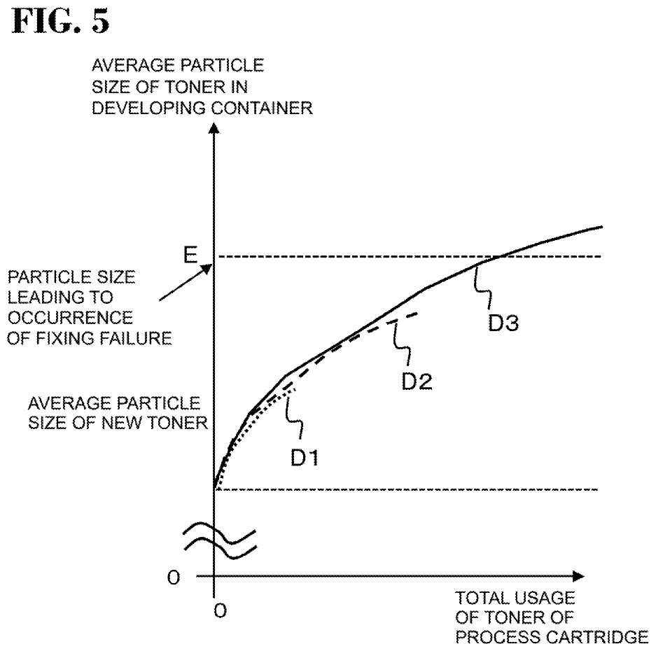

FIG. 5 is a graph illustrating a relationship between the total usage of toner of the process cartridge 3 at the end of life of the process cartridge 3 and the variation of the average particle size of toner in the developing container. The horizontal axis represents the total usage of toner, and the vertical axis represents the average particle size. In the graph, a curve D1 indicates a case where the average coverage rate is 2%, a curve D2 indicates a case where the average coverage rate is 5%, and a curve D3 indicates a case where the average coverage rate is 10%. The start point (left end in the figure) of each curve indicates the average particle size of new toner, and the end point (right end) indicates the average particle size at the end of life of the process cartridge. Under this condition, “at the end of life” is regarded as when the value related to the rotational speed of the developing roller 41 exceeds the life value, namely, a predetermined threshold. The total usage of toner is the total amount of the toner T used from the state where the process cartridge 3 is new to the time point of calculation, and can be referred to as the accumulated amount of consumed developer. The total usage of toner is also information regarding the total amount of the toner T consumed since start of use of the process cartridge 3, and can be referred to as consumption amount-related information. Note that the consumption amount-related information can include not only the specific weight of the toner but also the light quantity obtained by the light quantity detection sensor 6c and the current or voltage value converted from the light quantity. Further, a case where the consumption amount is calculated from the image information used at the image formation can also be considered to be included in the consumption amount-related information.

Here, it is assumed that use of a new process cartridge 3 has started, and the start time of use is defined as the starting point when the total usage of toner is calculated. However, the starting point of the calculation is not limited to the state in which the process cartridge 3 is completely unused. For example, after a test before shipment, image formation as a sample, or the like is performed, a timing at which the process cartridge 3 is attached to the image forming apparatus 1 to be actually used may be defined as the timing of start of use of the process cartridge 3.

Although number of developing rotations of the process cartridge 3 at the end of life is the same in all the curves D1, D2, and D3, because the average coverage rates are different from each other, the total usage of toner at the end of developing life increases in the order of D1, D2, and D3. In the curve D1 with a low average coverage rate, the total usage of toner at the end of life is small, and the total toner usage at the end of life increases as the average coverage rate increases.

As indicated in FIG. 5, as the total usage of toner of the process cartridge 3 is larger, the average particle size of the toner T in the developing container 44 is larger. Therefore, considering until the end of life of the process cartridge 3, the average particle size of the toner in the developing container 44 at the end of life increases as the average coverage rate increases. For example, in the case of the process cartridge 3K of the image forming apparatus 1 of the present example, the average coverage rate during general use is about 5%, and the average particle size transitions according to the curve D2 in FIG. 5.

The average particle size E represented by the vertical axis in FIG. 5 is a value at which fixing failure may occur if the average particle size exceeds this value in the image forming apparatus 1 of the present example. In the present example, the average particle size of a new toner is 7 μm, and the average particle size E at which a problem relating to fixing failure may occur is 10 μm.

At this time, when the average coverage rate indicated by the curve D2 is 5%, even if the process cartridge 3 is at the end of life, the average particle size of the toner in the developing container does not exceed E, and a fixing failure image is not formed. However, as indicated by the curve D3, in a case where the average coverage rate is 10%, the average particle size of the toner in the developing container exceeds E before the end of life of the process cartridge 3, and a fixing failure may occur.

### Countermeasure Against Increase in Toner Particle Size Due to Change of Remaining Amount of Toner

In the present Example, the control unit 100 executes the replenishing operation by driving the toner replenishment shutter 24 while referring to the signal from the toner remaining amount detection substrate 6a such that the average remaining amount of toner in the developing container 44 becomes a predetermined reference value (40 g in this case).

Here, as a target value of the remaining amount of toner in the developing container 44 is smaller, the toner T in the developing container 44 to be discarded at the end of life of the process cartridge 3 is smaller, which is advantageous in terms of cost. However, if the developing container 44 is not filled with a certain amount of toner, it is difficult to achieve an appropriate density when printing a printing pattern that consumes a large amount of toner T, such as a solid image. In view of the above point and others, the amount of toner in the developing container 44 is set to an appropriate value for each product.

Here, the variation in the average particle size of toner due to the increase in the total usage of toner described in the section “Increase in Toner Particle Size” is gentler as the amount of toner in the developing container 44 is larger. This is because when the amount of toner in the developing container 44 is large, the ratio of the toner having a large particle size is less likely to increase even if the amount of the toner having a large particle size generated in the regulating portion of the developing blade 42 is the same, and thus the variation in average particle size to the total usage of toner is gentle.

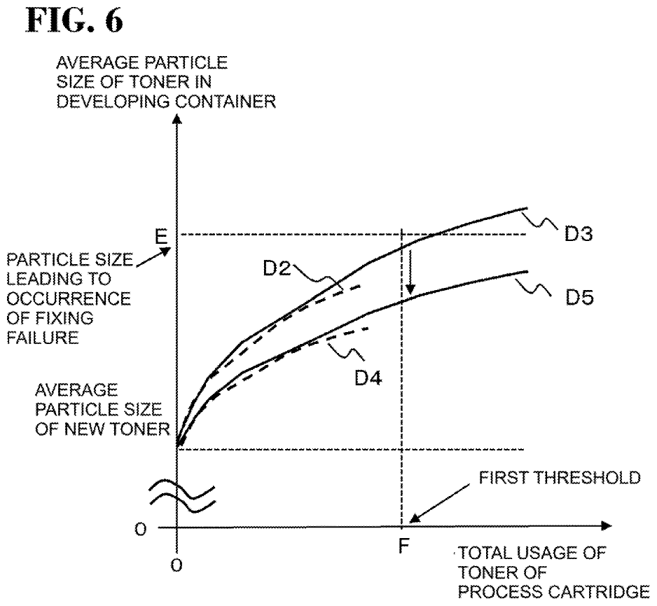

FIG. 6 is a graph indicating a relationship of the variation in the average particle size of toner for each remaining amount of toner in the developing container 44 until the end of life of the process cartridge 3 at each average coverage rate of Example 1. In the graph, the curve D2 indicates a case where the average coverage rate is 5% and printing is continued up to the number of sheets reaching the end of life while keeping the average remaining amount of toner remaining in the developing container 44 at 40 g. In the graph, the curve D3 indicates a case where the average coverage rate is 10% and the average remaining amount of toner in the developing container 44 is 40 g. In the graph, a curve D4 indicates a case where the average coverage rate is 5% and the average remaining amount of toner in the developing container 44 is 60 g. In the graph, a curve D5 indicates a case where the average coverage rate is 10% and the average remaining amount of toner in the developing container 44 is 60 g. In each of the curves D2 to D5, number of developing rotations of the process cartridge 3 at the end of life is equal. However, because the average coverage rates are different from each other, the total usage of toner at the end of development life is larger in the curves D3 and D5 than in the curves D2 and D4.

As can be seen from FIG. 6, in comparison with the curves D2 and D3 each indicating the case where the remaining amount of toner in the developing container 44 is 40 g, the curves D4 and D5 indicating the case where the remaining amount of toner is 60 g have a gentler variation in the average particle size of toner in the developing container 44 with respect to the total usage of toner.

However, in the curve D3 indicating the case where the average coverage rate is 10% and the remaining amount of toner in the developing container 44 is 40 g, the average particle size of toner in the developing container 44 exceeds E before the end of the life of the process cartridge 3, and a fixing failure may occur.

Therefore, in a case where the total usage of the toner T exceeds a first threshold F, the control unit 100 of the present example increases the remaining amount of toner in the developing container 44 from 40 g that is a predetermined reference value to 60 g. As described above, it is a feature of the present example to control the replenishing operation on the basis of the total usage of the toner T. Here, the first threshold F is set at a value slightly smaller than the total usage of toner when the average particle size of the toner reaches the threshold E at which a fixing failure occurs.

By changing the remaining amount of toner in the developing container 44 from 40 g to 60 g, the transition of the variation in toner particle size represented by the curve D3 shifts to the curve D5. That is, by increasing the remaining amount of toner when the total usage of toner is F, the transition of the average particle size thereafter shifts to the curve D5. In this manner, even at the average coverage rate of 10%, the average particle size of toner in the developing container 44 does not exceed E until the end of life of the process cartridge 3. Therefore, the occurrence of fixing failure is suppressed. In the present example, the first threshold F of the total usage of toner is set at 300 g.

In the present example, in a case where the remaining amount of toner is changed from 40 g to 60 g, the control unit 100 drives the toner replenishment shutter 24 during the image forming operation after the total usage of toner exceeds the first threshold F, and executes toner replenishment. In this way, by executing the toner replenishing operation during the image forming operation, the remaining amount of toner in the developing container 44 can be changed without causing downtime for the user.

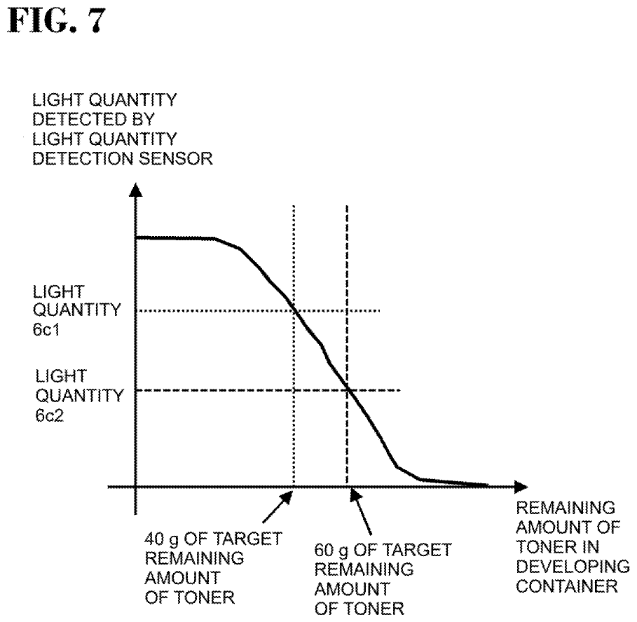

FIG. 7 indicates a relationship between the remaining amount of toner in the developing container 44 and the light quantity detected by the light quantity detection sensor 6c. FIG. 7 is a diagram for schematically explaining the target value of the light quantity of the light quantity detection sensor 6c when the remaining amount of toner in the developing container 44 is changed. In a case where the remaining amount of toner in the developing container 44 is 40 g, the control unit 100 executes the toner replenishing operation on the basis of the light quantity 6cl detected by the light quantity detection sensor 6c. In a case where the remaining amount of toner in the developing container 44 is changed from 40 g to 60 g, the toner replenishing operation is executed on the basis of the light quantity 6c2 detected by the light quantity detection sensor 6c.

### Variation

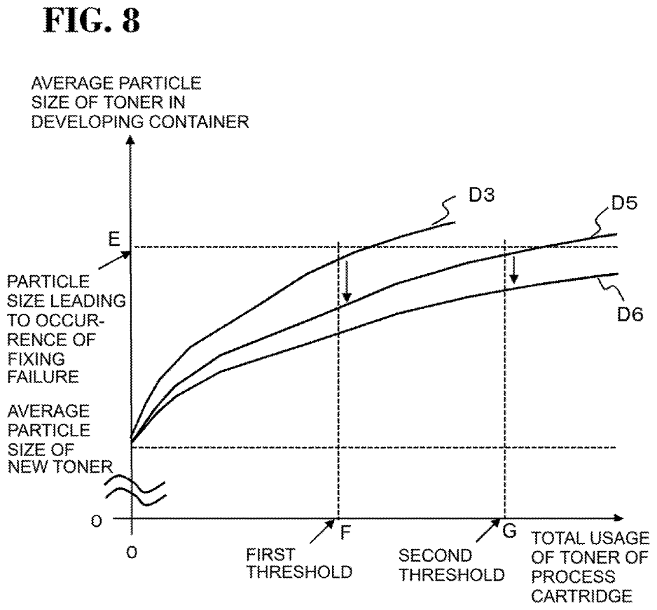

FIG. 8 indicates an example of a product in which the process cartridge 3 has a further extended life in Example 1. FIG. 8 indicates a variation in the average particle size of toner in the developing container 44 in the process cartridge 3 at each average coverage rate, and indicates a variation in a case where a plurality of total toner usage thresholds are given. Curves D3, D5, and D6 each indicate the variation of the average particle size of the toner in the developing container 44 with respect to the total usage of toner of the process cartridge 3 until the end of life of the process cartridge 3.

In the graph, compared to the curve D3, the curves D5 and D6 each indicate a case of a long-life process cartridge 3 having a life of 1.5 times as long as that of the curve D3. As described above, in the graph, the curve D3 indicates a case where the average coverage rate is 10% and the remaining amount of toner of the developing container 44 is 40 g. In the graph, the curve D5 indicates a case where the average coverage rate is 10%, the remaining amount of toner of the developing container 44 is 60 g, and the life of the process cartridge 3 is 1.5 times as long as the life of the process cartridge 3 of the curve D3. In the graph, the curve D6 indicates a case where the average coverage rate is 10%, the remaining amount of toner of the developing container 44 is 80 g, and the life of the process cartridge 3 is 1.5 times as long as the life of the process cartridge 3 of the curve D3.

In the curves D5 and D6 indicating the case of the long-life process cartridge 3, the total usage of toner at the end of life increases. Therefore, in a case where the total usage of toner exceeds the first threshold F, even if the remaining amount of toner in the developing container 44 is changed from 40 g to 60 g according to the method of Example 1 and transition is made to the curve D5, the average particle size of toner may exceed E again depending on the life of the process cartridge 3.

In the present variation, the control unit 100 sets a second threshold G to the total usage of toner and executes a toner replenishing operation such that the amount of toner remaining in the developing container 44 is changed to a third remaining amount of toner that is 80 g. As a result, the average particle size of toner in the developing container 44 is prevented from exceeding E again, whereby occurrence of fixing failure can be suppressed.

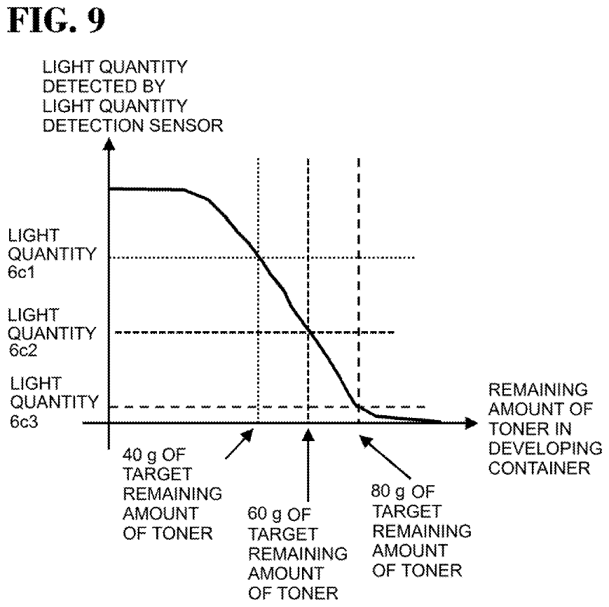

In a case where control is executed on the basis of the second threshold G of the present variation, as indicated in FIG. 9, the toner replenishment shutter 24 is operated on the basis of the light quantity 6c3 detected by the light quantity detection sensor 6c. FIG. 9 is a graph schematically indicating a target value of the light quantity of the light quantity detection sensor 6c when changing the remaining amount of toner in the developing container in a case where a plurality of total toner usage thresholds are given in Example 1.

Third and fourth thresholds may be set to the total usage of toner in accordance with the life of the process cartridge 3. In this case, the toner replenishing operation is executed such that the remaining amount of toner in the developing container 44 is also changed to the third and fourth remaining amounts of toner.

### Comparative Example

As a comparative example, a case where the remaining amount of toner in the developing container 44 is initially set at a larger value of 60 g will be described. Assuming that the remaining amount of toner in the developing container 44 is 60 g, the average particle size of toner in the developing container 44 varies as indicated by curves D4 and D5 in FIG. 6 at the average coverage rates of 5% and 10%, respectively. That is, when the remaining amount of toner is 60 g, the average particle size of toner in the developing container 44 does not exceed E until the end of life of the process cartridge 3 in both cases of the average coverage rate of 5% and the average coverage rate of 10%, and thus the occurrence of fixing failure is suppressed.

However, in the case of use with an average coverage rate of 5%, where a fixing failure image does not occur even when the remaining amount of toner in the developing container 44 is 40 g, if the remaining amount of toner is set at 60 g, 20 g of toner is excessively filled, such that the amount of toner to be discarded increases.

Therefore, in Example 1, assuming a general use with an average coverage rate of about 5%, the remaining amount of toner is initially set to be as small as 40 g. In addition, in a case where the use with a low frequency, that is, an average coverage rate of 10%, continues and the total usage of toner increases, the remaining amount of toner is changed to 60 g.

Table 1 is a comparison among Example 1, Comparative Example 1 (a case where the remaining amount of toner is uniformly 40 g), and Comparative Example 2 (a case where the remaining amount of toner is uniformly 60 g). Table 1 indicates the list of the average coverage rate (5% or 10%), whether the occurrence of a problem relating to fixing is found or not found, and whether the amount of unused toner is small or large (i.e., cost performance) for Example 1 and Comparative Example 1, and Comparative Example 2.

First, Comparative Example 1 will be examined. In the case of an average coverage rate of 5%, which has a relatively high frequency of use in the market, the problem is “not found”. However, in a case where the average coverage rate is 10%, the probability of occurrence of a problem relating to fixing increases although the frequency of use in the market is relatively low. Therefore, the problem is “found”.

Next, Comparative Example 2 will be examined. There is no problem relating to fixing. However, because the amount of toner discarded in an unused state increases, there is a problem in terms of cost performance.

Finally, as in Example 1, a configuration in which the remaining amount of toner in the developing container 44 is increased from 40 g to 60 g in a case where the total usage of toner exceeds the threshold F will be examined. In this case, a problem relating to fixing can be suppressed at any average coverage rate, and the amount of unused toner is suppressed.

TABLE 1

| Remaining | Average coverage | | Average coverage | |
|---|---|---|---|---|
| amount of | rate of 5% | | rate of 10% | |
| toner in | Problem | Amount of | Problem | Amount of |
| developing | relating to | unused | relating to | unused |
| container | fixing | toner | fixing | toner |
| <Comparative | Not found | Small | Found | Small |
| Example 1> | | | | |
| Uniformly 40 g | | | | |
| <Comparative | Not found | Large | Not found | Large |
| Example 1> | | | | |
| Uniformly 60 g | | | | |
| <Example 1> | Not found | Small | Not found | Small |
| Change at | | | | |
| threshold F | | | | |
| 40 g to 60 g | | | | |

### Example 2

In Example 2, in a case where the difference in the total usage of toner of a plurality of process cartridges 3 mounted on an image forming apparatus 1 exceeds a certain threshold, a control unit 100 executes a toner replenishing operation such that the remaining amount of toner in the developing container 44 is changed. Because the configuration other than the threshold setting for the total usage of toner and the control of the toner replenishing operation is the same as that of Example 1, the description thereof is not given.

In Example 1, the number of process cartridges 3 included in the image forming apparatus 1 may be one or more. In the case where the plurality of process cartridges 3 are provided in Example 1, the replenishing operation is executed such that the remaining amount of toner is changed for each process cartridge 3. On the other hand, in Example 2, the image forming apparatus 1 includes at least two process cartridges 3, and the control unit 100 executes a replenishing control on the basis of the difference in the total usage of toner between the process cartridges.

The image forming apparatus 1 according to the present example includes a plurality of process cartridges 3 of yellow (Y), magenta (M), cyan (C), and black (K), thereby enabling full-color printing. As described in the section of Image Forming Operation, the process cartridges 3Y, 3M, 3C, and 3K develop the toners T of the respective colors onto a transfer belt 5a in this order. The toner of each color developed on the transfer belt 5a is transferred onto a sheet by a secondary transfer roller 10 and fixed by a fixing device 7.

Because each toner T is transferred onto the transfer belt 5a in the order of Y, M, C, and K, on the transfer belt 5a, the yellow toner T is on the lowermost layer side, the magenta toner and the cyan toner T are layered in this order, and the black toner T is on the uppermost layer side. When each toner T is transferred onto the sheet by the secondary transfer roller 10, the order of the uppermost layer and the lowermost layer toners T is reversed, such that the yellow toner T is on the uppermost layer side and the black toner T is on the lowermost layer side on the sheet. The fixing device 7 of the present example includes a heating roller 7b including a heater on the printed surface side of the sheet. Therefore, on the sheet, the heat of the heater is easily transferred to the toner T (yellow) on the uppermost layer side, and the heat of the heater is hardly transferred to the toner T (black) on the lowermost layer side.

Typically, as the particle size of the toner T increases, larger thermal energy is required for melting. If the toner T cannot be appropriately melted, the adhesive force between the sheet after fixing and the toner T is weak. Therefore, in a case where the particle size of the toner T increases, it is necessary to appropriately melt the toner T by, for example, increasing the fixing temperature. However, if the thermal energy is excessively applied to the toner T, the toner T may be excessively melted, the excessively melted toner T may adhere to the fixing roller side or the toner T may be excessively soaked into the sheet, such that an appropriate density cannot be obtained in some cases. The thermal energy to be applied to the toner T by the fixing device 7 is set in an appropriate range in consideration of the above.

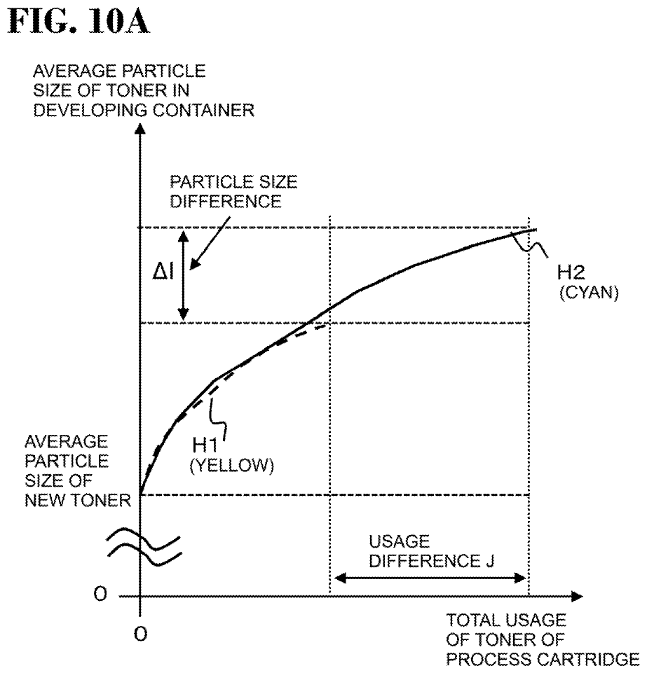

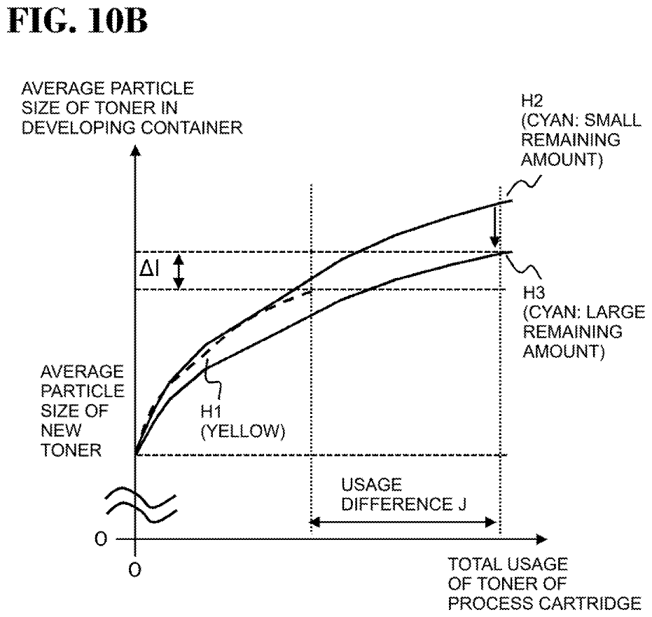

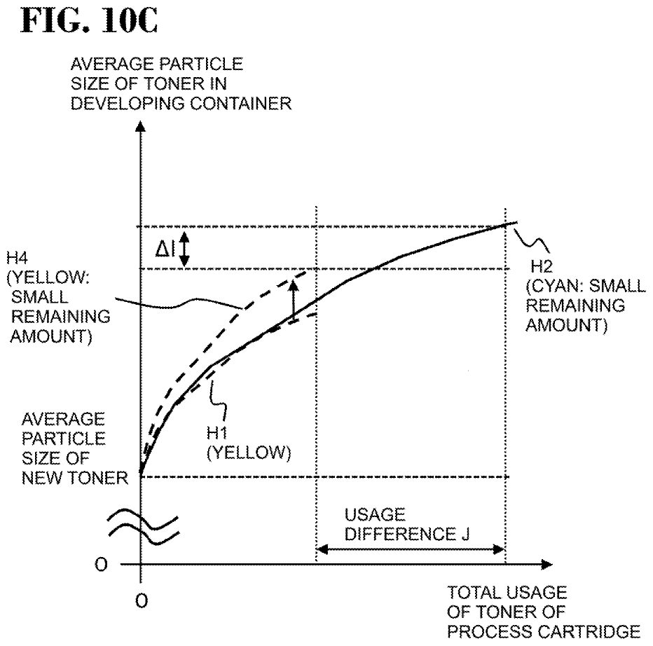

FIGS. 10A to 10C are graphs each indicating how the average particle size of toner in a developing container 44 varies in a case where the toner is used in a manner in which the average coverage rate greatly differs for each color. Here, a yellow process cartridge 3Y is defined as a first developing device, a photosensitive drum 63Y for yellow is defined as a first image carrier, a developing roller 41Y is defined as a first developer carrier, and a developing container 44Y is defined as a first developing container. A toner replenishment unit 20Y that stores the yellow toner T (first developer) is defined as a first replenishing container. A cyan process cartridge 3C is defined as a second developing device, a photosensitive drum 63C for cyan is defined as a second image carrier, a developing roller 41C is defined as a second developer carrier, and a developing container 44C is defined as a second developing container. A toner replenishment unit 20C that stores the cyan toner T (second developer) is defined as a second replenishing container.

FIG. 10A illustrates a relationship between the total usage of toner and the variation in average particle size when the yellow process cartridge 3Y passes 5000 sheets at an average coverage rate of 5% (curve H1) and the cyan process cartridge 3C passes 5000 sheets at an average coverage rate of 10% (curve H2). That is, a case where an image at a higher coverage rate is printed in cyan than in yellow is indicated. The remaining amount of toner in each of the developing containers 44 is 40 g.

In FIG. 10A, the usage difference J indicates a difference in the total usage of toner between the yellow process cartridge 3Y and the cyan process cartridge 3C. In this example, the usage difference (consumption amount difference) that is a difference obtained by subtracting the total usage of the cyan toner (second consumption amount-related information) from the total usage of the yellow toner (first consumption amount-related information) is calculated.

The particle size difference ΔI indicates a difference in average particle size of toner between the yellow developing container 44Y and the cyan developing container 44C when the usage difference is J. In other words, the average particle size of the yellow toner is smaller than the average particle size of the cyan toner by ΔI.

In this case, because the average particle size of the cyan toner T is larger than that of the yellow toner T, the thermal energy required for appropriate melting also increases. However, when the thermal energy required for melting the cyan toner T is applied by the fixing device 7, the yellow toner T having a small particle size may be excessively melted. More specifically, in a case where the particle size difference ΔI that is a difference between the average particle sizes of a first toner T and a second toner T exceeds a predetermined value, thermal energy for appropriately fixing both the first toner T and the second toner T may not be able to be set.

Therefore, in the present example, the particle size difference ΔI is estimated from the total toner usage difference J, and before the particle size difference ΔI exceeds a value at which a problem relating to fixing occurs, replenishing control is executed to reduce the particle size difference ΔI. Specifically, the control unit 100 executes a toner replenishing operation such that the target value of the remaining amount of toner in the cyan developing container 44 in which the total usage of toner is large is changed from a first reference value (40 g) to a second reference value (60 g) larger than the first reference value.

FIG. 10B is a graph illustrating control of the remaining amount of toner in the present example. In FIG. 10B, curves H1 and H2 are the same as those in FIG. 10A. That is, the curve H1 indicates the relationship between the total usage of toner and the average particle size in the case of the yellow toner T and the average coverage rate of 5%. The curve H2 indicates the relationship between the total usage of toner and the average particle size in the case of the cyan toner T and the average coverage rate of 10%. In both the curves H1 and H2, the remaining amount of toner in the developing container when the developing container is new is set at 40 g. A curve H3 indicates the relationship between the total usage of toner and the average particle size in the case of the cyan toner T, the average coverage rate of 10%, and the remaining amount of toner of 60 g.

As described above, fixing failure occurs in a case where the average particle size difference exceeds ΔI. Therefore, in the present example, in a case where the toner usage difference J exceeds a threshold (third threshold), the control unit 100 changes the remaining amount of toner in the cyan developing container 44 from 40 g to 60 g. As a result, the relationship of the variation in toner particle size corresponding to the total usage of toner shifts from the curve H2 to H3. At this time, the particle size difference between yellow and cyan varies from ΔIa (same as ΔI in FIG. 10A) to ΔIb. By reducing the particle size difference in this manner, the occurrence of fixing failure can be suppressed.

### Variation

In the above-described example, the control unit 100 executes the toner replenishing operation such that the target value of the remaining amount of toner in the cyan developing container 44 in which the total usage of toner is large is changed from the first reference value (40 g) to the second reference value (60 g) larger than the first reference value. However, the present invention is not limited to such control as long as the particle size difference ΔI can be reduced. For example, the control unit 100 may execute the toner replenishing operation such that the target value of the remaining amount of toner in the yellow developing container 44 in which the total usage of toner is small is changed from the first reference value (40 g) to a third reference value (30 g) smaller than the first reference value.

FIG. 10C illustrates the control of the present variation. In FIG. 10C, a curve H4 indicates a relationship between the total usage of toner and the average particle size in a case where the target value of the remaining amount of the yellow developing container 44 is changed to 30 g.

In a case where the target value of the remaining amount of toner in the developing container 44 of the process cartridge 3Y is changed to 30 g and the toner replenishing operation is executed, the transition of the average particle size of toner shifts to the curve H4. By this replenishing operation, the average particle size of toner is larger in comparison with the case of the curve H1. At this time, the particle size difference between yellow and cyan varies from ΔIa (same as ΔI in FIG. 10A) to ΔIc. By reducing the particle size difference in this manner, the occurrence of fixing failure can be suppressed.

Because the fixing device 7 of the present example includes a heating unit on the printed surface side of a sheet, in a case where the toner (yellow) on the uppermost layer side on the sheet is smaller in particle size than the other toner colors, excessive melting is likely to occur. On the other hand, in a case where the toner (cyan or black) on the lowermost layer side on the sheet is larger in particle size than the other toner colors, the thermal energy required for melting becomes insufficient, and a fixing problem due to insufficient melting is likely to occur. From this consideration, the state in which the average particle size of the toner T on the side closer to the heating unit is larger than the average particle size of the toner T on the side farther from the heating unit is more preferable than the opposite state. Therefore, when controlling the average particle size of the toner T of each color by the replenishing operation on the basis of the particle size difference ΔI, the control unit 100 may change the particle size difference ΔI for each combination of colors.

A difference in the total usage larger than the total toner usage difference J may be set for each color and control of changing the remaining amount of toner in the developing container 44 may be executed a plurality of times.

In the present example, in a case where the average particle size of the cyan toner T is 1 μm or more larger than the average particle size of the yellow toner T, a problem relating to fixing may occur. In this case, the particle size difference ΔI may be set at 1 μm. In the present example, the total toner usage difference J when the particle size difference ΔI is 1 μm is 300 g. Therefore, the control unit 100 monitors whether or not the difference in the total usage of toner exceeds 300 g, and executes the replenishing control of the present example in a case where the difference in the total usage of toner exceeds 300 g.

The control in Example 2 may be executed in combination with the control of Example 1, or the control in Example 2 may be executed independently. In order to execute Example 2, a plurality of thresholds may be provided as described in Example 1, and the remaining amount of toner may be changed stepwise.

According to the present disclosure, there can be provided an image forming apparatus that enables suppression of an adverse effect on an image due to a change in physical properties of toner in a configuration that enables toner replenishment to a process cartridge.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-068142, filed Apr. 17, 2025, which is hereby incorporated by reference herein in its entirety.

What is claimed is:

1. An image forming apparatus comprising:
an image carrier having a surface on which an electrostatic latent image is to be formed;
a developing device including a developer carrier and a developing container, the developer carrier configured to supply a developer to the electrostatic latent image, the developing container configured to support the developer carrier and to store the developer;
a replenishing container configured to replenish the developing container with the developer; and
a control unit configured to control a replenishing operation of the developer from the replenishing container to the developing container,
wherein
the control unit
controls the replenishing operation such that an amount of the developer stored in the developing container becomes a predetermined reference value, and
increases a target value of the amount of the developer stored in the developing container from the predetermined reference value, in a case where consumption amount-related information regarding a total amount of the developer consumed since start of use of the developing device exceeds a first threshold.

2. The image forming apparatus according to claim 1, wherein
the control unit further increases the target value of the amount of the developer stored in the developing container, in a case where the consumption amount-related information exceeds a second threshold larger than the first threshold after the target value of the amount of the developer stored in the developing container is increased from the predetermined reference value.

3. An image forming apparatus comprising:
a first image carrier and a second image carrier each having a surface on which an electrostatic latent image is to be formed;
a first developing device including a first developer carrier and a first developing container, the first developer carrier configured to supply a first developer to the electrostatic latent image on the first image carrier, the first developing container configured to support the first developer carrier and to store the first developer;
a second developing device including a second developer carrier and a second developing container, the second developer carrier configured to supply a second developer to the electrostatic latent image on the second image carrier, the second developing container configured to support the second developer carrier and to store the second developer;
a first replenishing container configured to replenish the first developing container with the first developer;
a second replenishing container configured to replenish the second developing container with the second developer; and
a control unit configured to control a replenishing operation of the first developer from the first replenishing container to the first developing container and a replenishing operation of the second developer from the second replenishing container to the second developing container,
wherein
the control unit
controls the replenishing operation such that an amount of the first developer stored in the first developing container becomes a predetermined reference value and controls the replenishing operation such that an amount of the second developer stored in the second developing container becomes a predetermined reference value, and
increases, in a case where a consumption amount difference obtained by subtracting second consumption amount-related information regarding a total amount of the second developer consumed since start of use of the second developing device from first consumption amount-related information regarding a total amount of the first developer consumed since start of use of the first developing device exceeds a third threshold, a target value of the amount of the first developer stored in the first developing container from the predetermined reference value.

4. An image forming apparatus comprising:
a first image carrier and a second image carrier each having a surface on which an electrostatic latent image is to be formed;
a first developing device including a first developer carrier and a first developing container, the first developer carrier configured to supply a first developer to the electrostatic latent image on the first image carrier, the first developing container configured to support the first developer carrier and to store the first developer;
a second developing device including a second developer carrier and a second developing container, the second developer carrier configured to supply a second developer to the electrostatic latent image on the second image carrier, the second developing container configured to support the second developer carrier and to store the second developer;
a first replenishing container configured to replenish the first developing container with the first developer;
a second replenishing container configured to replenish the second developing container with the second developer; and
a control unit configured to control a replenishing operation of the first developer from the first replenishing container to the first developing container and a replenishing operation of the second developer from the second replenishing container to the second developing container,
wherein
the control unit
controls the replenishing operation such that an amount of the first developer stored in the first developing container becomes a predetermined reference value and controls the replenishing operation such that an amount of the second developer stored in the second developing container becomes a predetermined reference value, and
decreases, in a case where a consumption amount difference obtained by subtracting second consumption amount-related information regarding a total amount of the second developer consumed since start of use of the second developing device from first consumption amount-related information regarding a total amount of the first developer consumed since start of use of the first developing device exceeds a third threshold, a target value of the amount of the second developer stored in the second developing container from the predetermined reference value.

5. The image forming apparatus according to claim 1, wherein
the developing device is a process cartridge attachable to a main body of the image forming apparatus.

6. The image forming apparatus according to claim 5, wherein
the replenishing container is a toner cartridge attachable to the developing device.

7. The image forming apparatus according to claim 1, further comprising a detector configured to detect the amount of the developer stored in the developing container;
wherein the control unit executes a replenishing operation based on a detection result by the detector such that the amount of the developer stored in the developing container becomes the predetermined reference value.

8. The image forming apparatus according to claim 1, wherein
the control unit calculates a consumption amount of the developer based on image information on an image developed by the developing device.
